(19) United States
(12) Patent Application Publication
(10) Pub. No.: US 2025/0363564 A1
(43) Pub. Date: Nov. 27, 2025

(54) Enhanced Eligibility Verification through Document Analysis

(71) Applicant: Jorie Healthcare Partners, LLC, Oak Brook, IL (US)

(72) Inventor: Salvador Lo, Naperville, IL (US)

(21) Appl. No.: 19/216,923

(22) Filed: May 23, 2025

Related U.S. Application Data
(60) Provisional application No. 63/651,671, filed on May 24, 2024.

(51) Int. Cl. G06Q 40/08; G06T 7/11; G06V 30/10; G06V 40/16

(52) U.S. Cl. CPC G06Q 40/08; G06T 7/11; G06V 30/10; G06V 40/172

(57) ABSTRACT

A computing system may be configured to store multiple API specifications for APIs exposed by payor computing systems. The computing system may iterate over the API specifications in order to verify payment coverage for a recipient of a service of a service provider. Iterating over the API specifications may include retrieving one of the stored API specifications, constructing a verification request based on a retrieved API and using the information included in a request to verify payment coverage from a service provider system, establishing an electronic connection with a payor computer system, and submitting the request to the payor computer system based on the retrieved API. A verification response received from the payor computer system may indicate whether the payor provides payment coverage for the recipient of the service. The computing system may send a response to the service provider indicating whether any payor provides payment coverage for the recipient.

### RELATED APPLICATIONS

This application claims the benefit of U.S. Provisional Patent Application No. 63/651,671 titled “Enhanced Eligibility Verification Through Document Analysis” and filed on May 24, 2024, which is incorporated by reference herein in its entirety.

### FIELD

The present disclosure relates to insurance verification systems and methods.

### BACKGROUND

Insurance verification can be a time consuming and error prone process. A typical process involves a service provider reviewing an insurance card or driver's license and comparing demographic information to Electronic Medical Records (EMRs) and/or Electronic Health Records (EHRs). A customer may initially be found ineligible for several reasons. For example, the customer may have an outdated insurance card because of a change in insurance that results from a change in employment. There may also be a difference between a name on an insurance card and a name included in the EMR.

A determination of ineligibility often leads a time-consuming process that involves service providers contacting multiple insurance providers in an attempt to determine whether the customer is covered by insurance. The process has included multiple people comparing demographic information included in an insurance card or driver's license to the information include in an EMR. This process can delay the customer patient check-in process and lead to manual entry errors and associated billing errors.

Therefore, there is a need in the art for insurance verification systems and methods that quickly and accurately verify insurance coverage even when demographic information included in an insurance card or driver's license is incomplete or does not exactly match the demographic information included in an EMR.

### BRIEF DESCRIPTION OF THE DRAWINGS

The present disclosure is illustrated by way of example and not limited in the accompanying figures in which like reference numerals indicate similar elements and in which:

FIG. 1 depicts a block diagram of an example computing environment that may be configured to automatically verify insurance coverage according to various aspects described herein.

FIG. 2 depicts an example entity-relationship diagram related to insurance coverage according to various aspects described herein.

FIG. 3 depicts an example entity-relationship diagram related to verifying insurance coverage according to various aspects described herein.

FIG. 4 is a flowchart of example method steps related to verifying insurance coverage according to various aspects described herein.

FIG. 5 is a flowchart of example method steps also related to verifying insurance coverage according to various aspects described herein.

FIG. 6 depicts an example of a computing device that may be used in implementing one or more aspects described herein.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure. Further, headings within this disclosure should not be considered as limiting aspects of the disclosure. Those skilled in the art with the benefit of this disclosure will appreciate that the example embodiments are not limited to the example headings.

Aspects of this disclosure relate to automated insurance verification systems and methods. Aspects of various embodiments are discussed in greater detail throughout this disclosure, including the accompanying drawings.

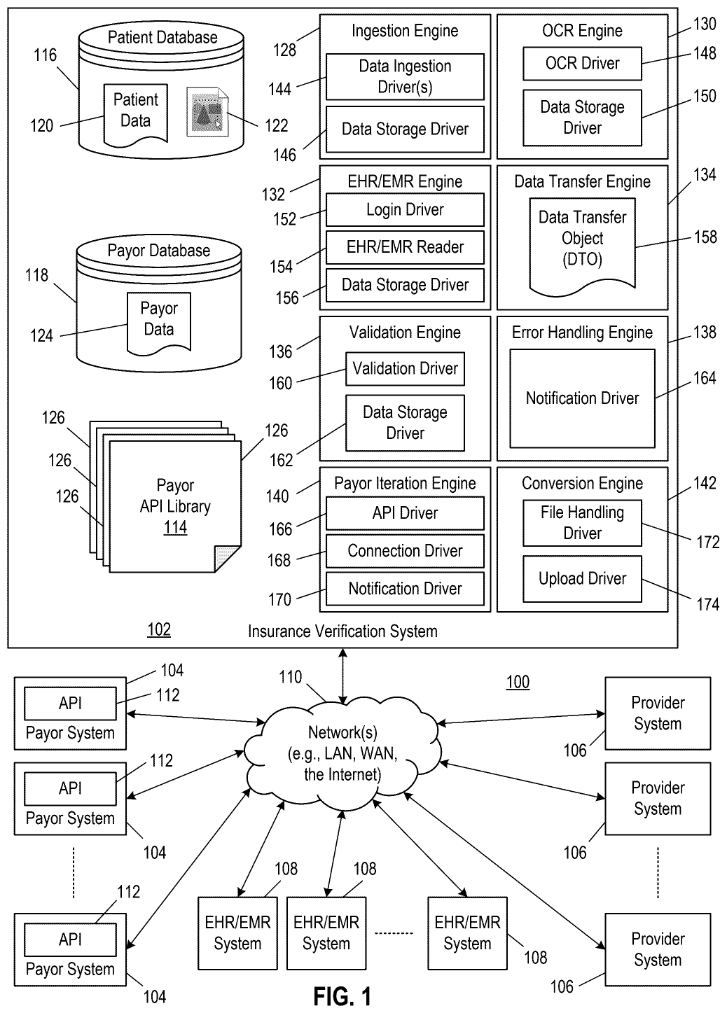

Referring to FIG. 1, a block diagram of an example computing environment 100 that may be configured to automatically verify insurance coverage according to various aspects described herein is shown. The example computing environment 100 depicted in FIG. 1 includes an insurance verification system 102, multiple payor systems 104, and multiple provider systems 106. The payor systems 104 each may be associated with a respective payor. A payor may be, for example, an insurance provider responsible for paying for provider services on behalf of an individual. The insurance provider may be, for example, a medical insurance provider, an auto insurance provider, a home insurance provider, and other types of insurance providers that provide insurance coverage to one or more covered individuals. Those covered individuals thus may include, for example, patients, vehicle owners, drivers, homeowners or renters, customers, and the like. Service providers may thus include, for example, hospitals, doctors' offices, dentists, therapists (e.g., physical and/or mental), rehabilitation specialists, mechanics, contractors, sub-contractors, other types of repair specialists, and the like. A payor also may be any entity that pays for services rendered to an individual or other entity (e.g., a business, an organization, etc.) on behalf of that individual or entity. The disclosures provided herein will be described, for convenience and without limitation, in the context of medical insurance whereby the payors are medical insurance providers, the service providers provide medical services, and the individuals are patients that receive the medical services.

The insurance verification system 102 may be in signal communication with multiple payor systems 104, multiple provider systems 106, and multiple EHR/EMR systems 108. In some scenarios, the insurance verification system 102 may be in signal communication with hundreds or even thousands of payor systems 104 that potentially provide insurance coverage for a given patient. The insurance verification system 102 may be in signal communication with the payor systems 104, provider systems 106, and EHR/EMR systems 108 via one or more networks 110. The networks 110 may include, for example, local area networks (LANs) and wide area networks (WANs) such as the global Internet. The networks 110 may include wired networks and wireless network (e.g., terrestrial cellular networks, satellite networks, and the like). As described herein, the insurance verification system 102 may communicate with a given payor system 104 using an application programming interface 112 (API) exposed by that payor system 104. In some cases, the API 112 exposed by a payor system 104 may be unique to that payor system (e.g., unique methods, parameters, and functionality). As such, the APIs 112 of different payor systems 104 may all be different. In other cases, multiple payor systems 104 may expose APIs 112 that all conform to a common standard, format, and/or configuration (e.g., common methods, parameters, and functionality). The insurance verification system 102 may be configured to invoke the APIs 112 of multiple payor systems 104 including APIs unique to individual payor systems and APIs common to multiple payor systems. In this way, the insurance verification system 102 can advantageously query multiple payor systems to verify insurance coverage for a patient using the appropriate API 112 associated with a given payor system 104.

The iterative insurance verification procedures described herein also advantageously provide a solution to the problem of stale insurance data in provider systems. For example, providers may store patient's insurance information in their system but fail to update it when a patient's insurance changes (e.g., due to changes in benefits, job changes, etc.). Even if a provider obtains a copy of a patient's insurance card during each visit, the provider may fail to update the stored insurance information to reflect any modifications to the patient's insurance coverage indicated on the patient's current insurance card. As a result, a mismatch may exist between the patient's stored insurance information at the provider system and the patient's current insurance information indicated on the patient's insurance card. As another example, the provider may incorrectly enter the patient's insurance information into the provider system (e.g., due to transcription errors or other human errors) also resulting in a mismatch between the stored patient information and the patient's insurance card information.

The insurance verification system 102, in this example, includes various databases, various engines, and a payor API library 114, which configure the insurance verification system to verify insurance coverage for a patient. The databases in this example insurance verification system 102 include a patient database 116 and a payor database 118. The patient database 116 stores, for example, patient data 120 and patients' insurance card images 122. The payor database 118 stores payor data 124. Although shown as separate databases in FIG. 1, the patient database 116 and payor database 118 may be implemented as a singular database. The patient database 116 and payor database 118 may be, for example, a relational database and accessed using a database management system (DBMS). Other types of data storage means may be used to store the patient data and/or the payor data (e.g., object-oriented databases, NoSQL databases, distributed data stores, etc.).

The payor data 124 may link or otherwise associate a payor with a corresponding API specification 126 in the payor API library 114. The payor API library 114 may provide the payor's API specification 126 as a set of function definitions exposed by the corresponding payor system 104. The function definitions may specify, for example, the function names, parameter names, and parameter ordering used to request patient insurance coverage and eligibility information from the payor. The function definitions may also specify the format and configuration of any responses provided by the payor system based on receiving such requests. The payor API library 114 may be configured to include API specifications 126 for every potential payor that may provide insurance coverage for patients receiving medical services. The payor API library 114 may be updated, for example, to add new API specifications 126 based on new payors entering the marketplace and/or to modify existing APIs based on changes to existing payors' APIs.

As described further herein, the engines of the insurance verification system 102, in this example, are configured to verify insurance coverage for a patient. To that end, the engines, in this example, include an ingestion engine 128, an optical character recognition (OCR) engine 130, an EHR/EMR engine 132, a data transfer engine 134, a validation engine 136, an error handling engine 138, a payor iteration engine 140, and a conversion engine 142. The respective engines may be implemented as a set of executable instructions organized as one or more statements, functions, routines, sub-routines, modules, scripts, and the like that are configured to, when executed, perform the intended functionality of the engine. The respective collections of executable instructions, therefore, are referred to for expedience as “engines” herein to convey the respective functional aspects of the insurance verification system 102, which may be implemented using one or more computing devices configured (e.g., programmed) with the collections of executable instructions stored as firmware and/or software by the one or more computing devices in non-volatile (e.g., read-only) memory and/or volatile (e.g., random access) memory.

The insurance verification process may be initiated (e.g., triggered) based on (e.g., in response to) the insurance verification system 102 receiving a request for insurance verification from a payor system. The request may include patient data (e.g., patient name, date of birth, state, etc.) and an image of the patient's insurance card. The request from the provider also may indicate the medical service to be provided to the patient in order to verify that the patient not only has current insurance coverage but also that the identified medical service is covered by the patient's current insurance. In some examples, a provider may send, via its provider system 106, a batch request indicating multiple patients that need insurance verification. The patients listed in the batch request may include patient whose insurance coverage could not be verified. The batch request may be sent as an input file to the insurance verification system 102, and the insurance verification procedures described herein may be performed for each patient listed in a batch request. Additionally or alternatively, the insurance verification system 102 may request the patient information from the provider systems (e.g., automatically at regular intervals, on-demand, etc.). For example, the insurance verification system 102 may retrieve a report identifying one or more patients needing insurance verification. As another example, the insurance verification system 102 may identify one of more patients needing insurance verification via screen scraping the provider systems 106.

The ingestion engine 128, in this example, is configured to ingest and store information used to verify insurance coverage for a patient. The ingested information may include patient data (e.g., first and last name, gender, date of birth, social security number (SSN) or other unique identifier, state of residence, etc.) as well as insurance information. The insurance information may be ingested as text or as an image of the patient's insurance card. The ingestion engine 128 may ingest some or all of the patient data and from a provider system 106. The ingestion engine 128 may thus include one or more data ingestion drivers 144 configured to ingest (e.g., via a request/response protocol) the patient data and insurance information from the provider systems 106. For example, a client may be installed at the provider systems 106 configured to integrate into the provider system and respond to requests for patient data and insurance information. Additionally or alternatively, some or all of the patient data and insurance information may be ingested from an EHR/EMR system 108 that stores the patient data. The data ingestion engine 128 may thus include a data ingestion driver 144 configured to ingest the patient data and the insurance information from the EHR/EMR systems 108. The data ingestion driver 144 thus may be configured to log in to the EHR/EMR systems 108, request patient data from the patient's EHR/EMR records, and parse the patent data received (e.g., read a table of patient data returned by an EHR/EMR system). The data ingestion engine 128 may be configured to ingest data from additional and alternative sources including, for example, data tables (e.g., exported data tables), computer vision (CV) table readers, API calls using one or more healthcare data standards (e.g., Fast Healthcare Interoperability Resources or FHIR), and the like. The data ingestion engine 128 may also be configured to store the ingested data into the patient database 116. It will be recognized with the benefit of this disclosure that the data ingested by the data ingestion engine 128 may be incomplete and, as a result, not yet suitable for eligibility verification. The workflows described herein are configured to retrieve any missing or supplemental data needed to verify insurance eligibility.

The insurance verification system 102 may include a data ingestion driver 144 for each source of data ingested into the system or method of ingesting data into the system. The insurance verification system 102 may employ standardized data models for ingesting data into the system, for example, a standardized patient data model, a standardized encounter data model, and a standardized coverage data model. In some examples, the insurance verification system 120 may employ multiple, different standardized patient data models, standardized encounter data models, and/or standardized coverage data models. The insurance verification system 102 may employ additional types of standardized data models for other entities related to insurance eligibility verification. A data ingestion driver 144 may include a conversion function that maps the incoming raw data to the standardized data model. Use of these data ingestion drivers 144 and standardized data models advantageously enables the insurance verification system 102 to verify insurance eligibility regardless of the source or method of obtaining the data needed for eligibility verification. A standardized patient data model may include, for example, patient name, date of birth, sex, address (e.g., at least the two-letter state abbreviation), and the like. A standardized encounter data may include, for example, a unique identifier (e.g., the provider's tax ID, the provider's National Provider Identifier or NPI assigned by the National Plan and Provider Enumeration System or NPPES) and an appointment date or service date (e.g., a historical, future, and/or current appointment or service date). A standardized coverage data model may include, for example, the name of the insurer or payor, a subscriber ID, an indication of the relationship to the subscriber, and a filing order (e.g., primary, secondary, etc.). The data ingestion engine 128 may include a data storage driver 146 configured to store the ingested data in the patient database 116.

The OCR engine 130, in this example, is configured to read patient data depicted in an ingested image of a patient's insurance card 122 and store the recognized patient data in the patient database 116. The input to the OCR engine 130, therefore, may include the insurance card image 122 and the output may include any patient data 120 recognized in and read from the insurance card image. The OCR engine thus may include an OCR driver 148 configured to perform the OCR procedure. In some cases, the patient data depicted in an ingested insurance card image 122 may be relatively more or less challenging to recognize depending on the quality of the image (e.g., it may be relatively more challenging to recognize patient data in low quality and/or low resolution insurance card images). To improve the likelihood of successfully recognizing patient data in insurance card images 122, the OCR driver 148 may be configured to employ artificial intelligence (AI) and/or machine learning (ML) technologies to assist in the OCR procedure. For example, the form and content of insurance cards across different insurance providers may vary significantly (e.g., different logos, different patient data, different placement of patient data, etc.). As such, one or more ML models (e.g., image classification models, image segmentation models, etc.) may be trained to recognize insurance cards associated with particular insurance providers and trained to recognize patient data in the respective insurance cards for their corresponding insurance providers. The ML models may include, for example, neural networks such as convolution neural networks (CNNs), artificial neural networks (ANNs), recurrent neural networks (RNNs); decision trees and ensemble trees; linear equations; transformer models; logistic regression models; support vector machines (SVMs); classifier algorithms such as naïve Bayes classifiers, discriminant analyses, clustering algorithms such as k-nearest neighbor (KNN) algorithms; and the like. An image classification model may be trained using insurance card images labeled with an indication of an identity of the payor (e.g., insurance provider). For example, multiple insurance card images labeled with an indication of a first payor and multiple insurance card images labeled with an indication of a second payor may be used to train an image classification model. An insurance card image may then be provided to the trained image classification model to determine which payor the insurance image is associated with (e.g., the first payor or the second payor). One or more image segmentation models may be associated with each payor and trained to segment (divide) an insurance card image into multiple segments (regions) that each provide an item of data for the insured (e.g., patient name, patient date of birth, patient ID, etc.). An image segmentation model may be trained using insurance card images of a given payor labeled with indications of the various segments (regions) of the insurance card and the type of information each respective segment (region) contains. The OCR engine 130 thus may employ the trained ML models (e.g., a trained ML model for each known insurance provider) to recognize which insurance provider an ingested insurance card image 122 is associated with (e.g., using a trained image classifier model) and recognize the patient data depicted in the insurance card image (e.g., using a trained image segmentation model for the identified payor). The OCR engine 130 thus may be configured to employ an image segmentation model associated with an identified payor to recognize and extract the information used to verify insurance coverage from the insurance card image received. The OCR engine 130 may also include a data storage driver 150 configured to store the insurance card images 122 and the recognized patient data 120 in the patient database 116. The trained ML models may be continually updated and reinforced as new insurance card images are received and processed.

The EHR/EMR engine 132, in this example, is configured to obtain patient data from one or more of the EHR/EMR systems 108 and store the patient data 120 obtained in the patient database 116. The EHR/EMR engine 132, in this example, thus includes a login driver 152, an EHR/EMR reader 154, and a data storage driver 156. The login driver 152 may be configured to connect to one or more of the EHR/EMR systems 108 and handle any login procedures the EHR/EMR systems use to grant access to their EHR/EMR records. A login driver 152 may be configured to access multiple EHR/EMR systems 108. Additionally or alternatively, multiple login drivers 108 may each be configured to access individual EHR/EMR systems respectively. The EHR/EMR engine 132 may be configured to query the EHR/EMR systems 108 for EHR/EMR records associated with a patient and, in response to such queries, receive the patient's EHR/EMR records and/or the patient data they contain. The EHR/EMR records and/or the patient data that the EHR/EMR engine 132 receives may be in a format (e.g., a table format) unique to the EHR/EMR system 108 that provided it. The EHR/EMR reader 154, therefore, may be configured to process (e.g., parse, extract, etc.) the formatted patent data received from an EHR/EMR system 108 to prepare it for storage in the patient database 116. Similar to the login driver 152, the EHR/EMR reader 154 may be configured to process EHR/EMR records and/or patient data received from multiple EHR/EMR systems 108. Additionally or alternatively, multiple EHR/EMR readers 154 may each be configured to process EHR/EMR records and/or patient data received from individual EHR/EMR systems 108 respectively. The data storage driver 156 of the EHR/EMR engine 132 may be configured to store the patient data 120 received from the EHR/EMR systems 108 in the patient database 116.

The data transfer engine 134, in this example, is configured to retrieve patient data 120 from the patient database 116 and prepare it for validation and insurance verification. The data transfer engine 134 thus may be configured to prepare a data transfer object (DTO) 158 containing the patient data 120. The DTO 158 may be a data structure that packages (e.g., organizes, arranges, formats, etc.) the patient data 120 for downstream use by, for example, the validation engine 136 and the payor iteration engine 140. The DTO 158 may include, for example, the patient name, gender, date of birth, unique identifier (e.g., SSN), and state of residence. The data transfer engine 134, in this example, provides the DTO 158 for validation prior to insurance verification.

The validation engine 136, in this example, is configured to ensure the patient data necessary for insurance verification is available. Ensuring the availability of sufficient patient data may be referred to, for convenience, as validation. The validation engine 136, in this example, thus includes a validation driver 160 configured to determine whether the patient data is sufficient for insurance verification. For example, the validation engine 136 may be configured to identify any missing patient data that is needed for insurance verification. The validation driver 160, therefore, may be configured to process the DTO 158 received from the data transfer engine 134, evaluate the patient data 120 included in the DTO 158, and determine a validation status for the patient data. As such, the input to the validation engine 136 may be the DTO 158 and the output of the validation engine may be the validation status. The validation status may include the patient's unique identifier, a status value (e.g., “1” or “yes” for successful validation, “0” or “no” for unsuccessful validation), and a status message. The status message may include, for example, an indication of which patient data was missing and/or a statement explaining why the patient data could not be validated. The data storage driver 162 of the validation engine 136 may be configured to store the validation status in the patient database 116. The validation engine 136 also may be configured to invoke either the error handling engine 138 or the payor iteration engine 140 depending upon successful or unsuccessful validation of the patient data 120. Based on (e.g., in response to) unsuccessful validation of the patient data 120, the validation engine 136 may invoke the error handling engine 138 to notify a provider the patient data for a patient could not be validated. Based on (e.g., in response to) successful validation of the patient data 120, the validation engine 136 may invoke the payor iteration engine 140 to perform insurance verification for the patient.

The error handling engine 138, in this example, is configured to notify a provider when the patient data 120 for a patient cannot be verified. The error handling engine 138, in this example, thus includes a notification driver 164 that sends a notification to a provider indicating the validation status for a patient (e.g., successful or unsuccessful and any accompanying status message). The notification driver 164 may be configured to send the notification to a provider through any suitable communication channel (e.g., via a dashboard message presented by client installed at the provider system, an electronic mail (email) message, a phone call/voicemail, etc.). Providers may indicate a preferred means for receiving validation notifications, and the notification driver 164 may be configured to send the notification to providers using their preferred notification means. The notification driver 164 also may be configured to use a default means of sending a validation notification to a provider.

The payor iteration engine 140, in this example, is configured to verify a patient's insurance coverage using an iterative methodology. In particular, the payor iteration engine 140 is configured to iterate over a list of payors and use the payor's corresponding API specification 126 from the payor API library 114 to identify any payor that provides insurance coverage for a patient. The payor iteration engine 140, in this example, thus includes an API driver 166, a connection driver 168, and a notification driver 170. The API driver 166, in this example, is configured to retrieve, from the payor API library 114, the corresponding API specification 126 for the payor of a current iteration. The connection driver 168, in this example, is configured to establish a connection with the corresponding payor system 112 for the payor of the current iteration. The API driver 166 is further configured to request, via the connection driver, insurance coverage and eligibility information for the patient using the function definitions as indicated in the API specification 126 for that payor. The payor iteration engine 140 may be configured to iterate over the payors sequentially (e.g., querying only one payor at a time) or in parallel (e.g., querying multiple payors simultaneously). The payor iteration engine 140 may be configured to order (or otherwise rank) payors and iteratively query the payors according to an ordering or ranking. For example, the payor iteration engine 140 may be configured to order the payors based on the size of their insured populations (e.g., query the payors with a relatively higher quantity of insured individuals before querying payors with a relatively lower quantity of insured individuals), which may improve the chances of verifying insurance for a patient during earlier rather than later iterations. Additionally or alternatively, the payor iteration engine 140 may be configured to query the payors based on certain patient data associated with a patient. For example, the payor iteration engine 140 may be configured to first query payors that are located in (or otherwise operate in) the patient's state of residence and then, if unsuccessful, subsequently query payors located in other states or geographic regions (e.g., any of the patient's previous states of residence). The payor iteration engine 140 may be configured to iterate over the payor's based on a combination of payor data and patient data. For example, the payor iteration engine 140 may be configured to determine the payors that are located or operate in the patient's state of residence and then order those payors based on one or more criteria (e.g., the respective sizes of their insured population). The payor iteration engine 140 also may be configured to submit multiple queries (e.g., in sequence or in parallel) to a given payor's payor system in order to verify insurance coverage for a patient. For example, if there is a mismatch between the patient's name indicated on the insurance card and the patient's name indicated in the EHR/EMR records, then the payor iteration engine 140 may query the payor system 104 using each name associated with the patient (e.g., married name versus maiden name, alternative spellings, etc.). The payor iteration engine 140 may be configured to indicate whether the iterative queries of the available payor systems 112 identified any payor that provides insurance coverage for the patient. As such, the output of the payor iteration engine 140 may be an indication of whether the DTO 158 generated for the patient is active or inactive (e.g., active: “true”/“T”/“1” or active: “false”/“F”/“0”). The payor iteration engine 140 also may be configured to send to a provider system 106, using the notification driver 170, the results of the search for the patient's insurance coverage and eligibility information (e.g., whether the patient's DTO is active). If the payor iteration engine 140 is unable to verify insurance coverage for the patient from any of the queried insurance providers, then the payor iteration engine 140 may send to a provider system 106, using the notification driver 170, an indication that the patient is not active for any payor. Notifications may be sent using any suitable means including those described herein (e.g., via a client dashboard message, email, phone call/voicemail, etc.). If the payor iteration engine 140 determines that the patient's DTO 158 is active for a given payor, then the payor iteration engine 140 may fetch, using the selected API specification 126 for that payor, the patient's eligibility information. The fetched eligibility information may include patient data (e.g., a unique identifier for the patient, the patient's name, the patient's date of birth, etc.), eligibility data (e.g., the date of last verification, etc.), insurance data (e.g., a unique identifier for the patient's insurance, insurer name, start date, end date, etc.), and coverage data (e.g., a description of the covered medical service(s), coverage amount(s), deductible(s), copay(s), etc.). Having received the eligibility information, the payor iteration engine 140 may provide it to the conversion engine 142 that prepares it for sending to the provider system 106 and/or updating the patient's EHR/EMR records.

The payor iteration engine 140 also may be configured to iterate over a list of APIs (e.g., Availity, pVerify) for a given payor in order to verify insurance eligibility. For example, the insurance verification system 102 may store a list of APIs that can be used to verify insurance eligibility with a payor. The list of APIs may indicate a primary (e.g., default) API to first use in an attempt to verify insurance eligibility and one or more secondary (e.g., backup) APIs to use in the event eligibility cannot be verified via the primary API (e.g., due timeouts, network failure, or other otherwise). In this way, the insurance verification system 102 is configured with a fallback redundancy mechanism that can iteratively attempt to verify insurance eligibility verification in a cascading manner using the APIs available for a given payor. This cascading eligibility verification design advantageously allows the insurance verification system 102 to scale the available means for verifying insurance eligibility as new APIs are developed. For example, any additional (e.g., new) APIs can be added to a payer's list of preferred APIs for insurance eligibility verification. An API-specific identifier may be assigned to a payor. Each payor, therefore, may be associated with multiple API-specific payor IDs (e.g., a first payor ID for a first API and a second payor ID for a second API). The insurance verification system 102 may be configured to map the payor name and/or ID to the payor's API-specific payor IDs (e.g., to use with a given API when using that API to verify insurance eligibility). The payor iteration engine 140, for example, may be configured to map a payor name and/or ID to the API-specific payor ID.

The payor iteration engine 140 also may be configured to dynamically generate the payload for an API during insurance eligibility verification. For example, the payor iteration engine 140 may be configured to generate an appropriately formatted payload for each API used for insurance eligibility verification. Payload generation may include converting the data needed for insurance eligibility verification via a given API to match the data schema, field requirements, and the like for that API. In some examples, the standardized data models (e.g., the standardized patient data model) may include one or more conversion functions configured to transform the standardized data (e.g., standardized patient data) into a payload that is properly formatted for the API being used for the current iteration of insurance eligibility verification. In this way, the payor iteration 140 engine may attempt to verify insurance eligibility at multiple, different payors (e.g., at a first payor using a first payload configured according to a first payor format and at a second payor using a second payload configured according to a second payor format).

Similar to the inputs into the APIs, the APIs may provide insurance eligibility responses in different formats. For example, a first API may provide a first insurance eligibility response according to a first response format and a second API may provide a second insurance eligibility response according to a second response format. The format of respective insurance eligibility responses may be different even if the underlying insurance eligibility information (e.g., verified or not verified) is the same. The payor iteration engine 140, therefore, may be configured to convert responses received from respective APIs into a standardized response format. The insurance verification system 102 thus may employ a standardized eligibility response data model to provide a uniform view of the eligibility response data received from different APIs. In some examples, a standardized eligibility response data model may include data indicating the particular API that provided the eligibility response, data about the eligibility verification transaction (e.g., statue, timestamp, unique ID), patient data (e.g., demographic information provided by the payor), subscriber data (e.g., demographic information for the subscriber), coverage data (e.g., eligibility status, effective date range, plan name, extended plan information), benefit details (e.g., one or more service types such as general, surgical, in-patient, etc.), network details (e.g., in-network, out-of-network, etc.), amount details (e.g., amount total, amount met, amount remaining and amount type such as deductible, copay, coinsurance, etc.) In some examples, standardized data models may be employed for benefit details (e.g., a standardized benefit data model), network details (e.g., a standardized network data model), and amount details (e.g., a standardized amount data model). A standardized eligibility response may be stored or transmitted using any suitable format, e.g., a JSON format.

The conversion engine 142, in this example, is configured to receive eligibility information from the payor iteration engine 140 and convert it to a format suitable for sending (or otherwise providing it or making it available) to the provider. For example, the conversion engine 142 may be configured to instantiate a file object from a file object class, populate the file object with the eligibility information, and upload the populated file object to a shared folder accessible to both the insurance verification system 102 and the payor's payor system 112. As such, the conversion engine 142, in this example, includes a file handling driver 172 configured to instantiate and populate the file object and an upload driver 174 configured to upload the populated file object to the shared folder. Additionally or alternatively, the conversion engine 142 may send the populated file object to the payor system 104 via, for example, a client installed at the payor system and/or email.

It will be appreciated that certain terminology used herein has been selected for convenience and without limitation. For example, the various engines discussed herein may also be referred to as respective modules of the insurance verification system and may be implemented as one or more corresponding functions, routines, sub-routines, and instruction sets as needed to provide the described functionality. As such, the insurance verification system 102 may be implemented using computer-readable and computer-executable instructions, stored on non-transitory computer readable media that, when executed by one or more processors of the insurance verification system, cause and configure the insurance verification system to perform the functionality described with respect to the various engines discussed above. Furthermore, the insurance verification system 102 may be implemented as a single computing device (e.g., a combined web and application server) or as a collection of distributed and interconnected (e.g., networked) computing devices each being configured to perform respective aspects of the insurance verification process.

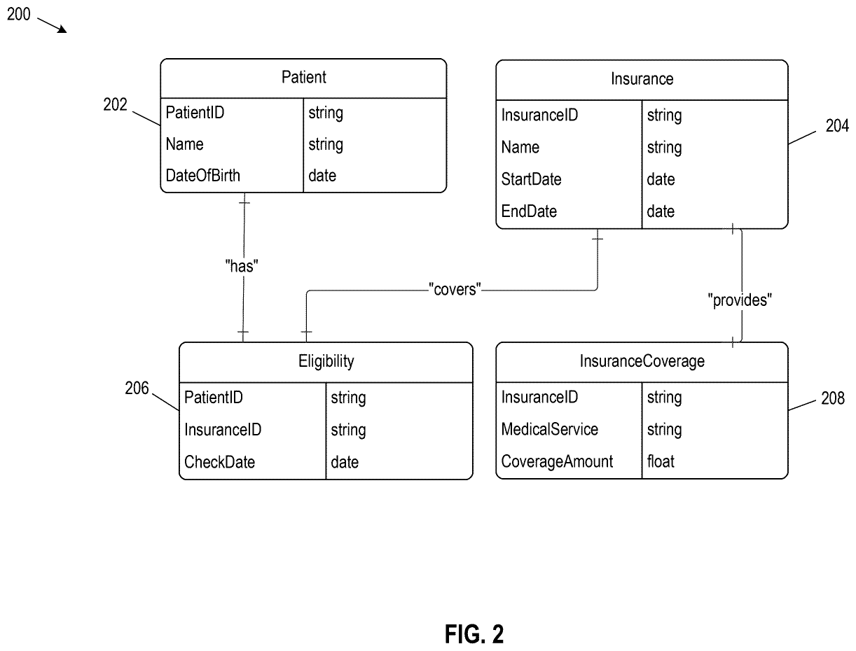

In FIG. 2, an example entity-relationship (ER) diagram 200 related to insurance coverage according to various aspects described herein is shown. The example ER diagram 200 shown in FIG. 2 includes a patient entity 202, an insurance entity 204, an eligibility entity 206, and an insurance coverage entity 208. The patient entity 202, in this example, includes fields indicating a unique patient identifier (e.g., the primary key of the patient entity), the patient's name, and the patient's date of birth. The patient entity 202 may include additional or alternative fields indicating characteristics of or other data associated with the patient. The eligibility entity 206, in this example, includes fields indicating a unique patient identifier (e.g., a foreign key for the eligibility entity), a unique insurance provider identifier (e.g., a foreign key for the eligibility entity), and a date indicating when the most recent insurance verification was performed. The eligibility entity 206 may include additional or alternative fields indicating characteristics of or other data associated with the patient's insurance coverage and eligibility information. The insurance entity 204, in this example, includes fields indicating a unique insurance provider identifier (e.g., a primary key of the insurance entity), a name of the insurance provider, a start date of the patient's insurance coverage, and an end date of the patient's insurance coverage. The insurance entity 204 may include additional or alternative fields indicating characteristics of or other data associated with the insurance provider. The insurance coverage entity 208, in this example, includes fields indicating a unique insurance provider identifier (e.g., a foreign key for the insurance coverage entity), an indication of the medical service covered, and a coverage amount (e.g., a coverage maximum). The insurance coverage entity 208 may include additional or alternative fields indicating characteristics of or other data associated with the insurance coverage provided to the patient. The patient entity 202, in this example, is directly related (via a one-to-one mandatory relationship) to the eligibility entity 206 to convey that a patient “has” eligibility for insurance coverage. The insurance entity 204, in this example, is directly related (via a one-to-one mandatory relationship) to the eligibility entity, and thus indirectly related to the patient entity 202 via the patient-eligibility relationship, to convey that an insurance provider “covers” the insurance eligibility that the patient has. The insurance entity 204, in this example, also is directly related (via a one-to-one mandatory relationship) to the insurance coverage entity 208 to convey that the insurance provider “provides” the insurance coverage for the patient. As such, the patient entity 202 also is indirectly related to the insurance coverage entity 208 via the patient-eligibility relationship, the eligibility-insurance relationship, and the insurance-insurance coverage relationship. As seen in FIG. 2, the entities are related to one another via their unique identifiers, which may serve as primary keys and foreign keys in the respective entities.

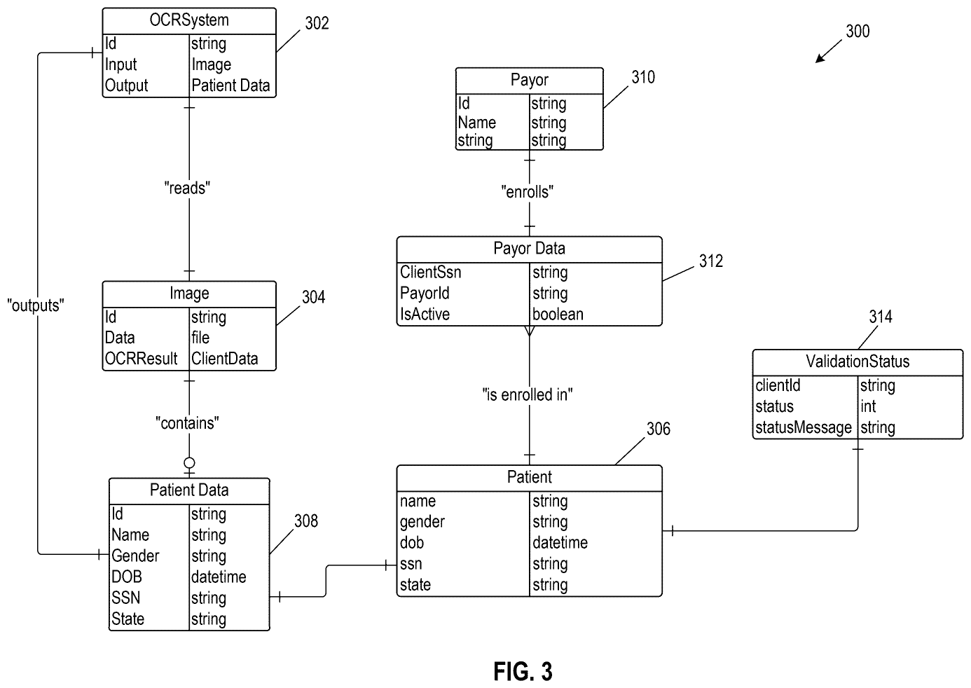

In FIG. 3, an example ER diagram 300 related to verifying insurance coverage according to various aspects described herein is shown. The example ER diagram 300 shown in FIG. 3 includes an OCR system entity 302, an image entity 304, a patient entity 306, a patient data entity 308, a payor entity 310, a payor data entity 312, and a validation status entity 314. The OCR system entity 302, in this example, includes fields indicating a unique identifier (e.g., the primary key of the OCR system entity), an input to the OCR process (e.g., an image of a patient's insurance card, which may correspond to an entry/record in the image entity), and an output of the OCR process (e.g., patient data recognized in and read from the image of the insurance card, which may correspond to an entry/record in the patient data entity). The OCR system entity 302 may include additional or alternative fields indicating other data associated with the OCR procedure. The image entity 304, in this example, corresponds to the image of a patient's insurance card and includes fields indicating a unique identifier (e.g., the primary key of the image entity), data associated with the image of the patient's insurance card (e.g., an image file), and a result of the OCR process (e.g., the data recognized in and read from the insurance card image). The image entity 304 may include additional or alternative fields indicating other data associated with an insurance card image. The patient entity 306, in this example, includes fields indicating a unique identifier (e.g., the primary key of the patient entity) such as the patient's SSN, the patient's name, the patient's gender, the patient's date of birth (e.g., a timestamp), and the patient's state of residence. The patient entity 306 may include additional or alternative fields indicating other data associated with the patient. The patient data entity 308, in this example, includes a unique identifier (e.g., the primary key of the patient data entity) as well as fields that are similar to those of the patient entity such as the patient's name, the patient's gender, the patient's date of birth, the patient's SSN, and the patient's state of residence. The patient data entity 308 may include additional or alternative fields indicating other data associated with the patient. The payor entity 310, in this example, includes fields indicating a unique identifier (e.g., the primary key of the payor entity), the name of the payor, and a description of the payor. The payor entity 310 may include additional or alternative fields indicating other data associated with the payor. The payor data entity 312, in this example, includes a unique identifier for the payor (e.g., a foreign key of the payor data entity), a unique identifier for the patient (e.g., a foreign key of the payor data entity) such as the patient's SSN, and an indication of whether insurance coverage for the patient is active (e.g., a Boolean value). The payor data entity 312 may include additional or alternative fields indicating other data associated with the relationship between a payor and a patient. The validation status entity 314, in this example, includes fields indicating a unique patient identifier (e.g., a foreign key of the validation status entity), a validation status, and a validation status message. The validation status entity 314 may include additional or alternative fields indicating other data associated with validation of the patient and the patient's corresponding patient data. The OCR system entity 302, in this example, is directly related (via a one-to-one mandatory relationship) to the image entity 304 to convey that the OCR engine of the insurance verification system “reads” the image of the patient's insurance card. The OCR system entity 302, in this example, also is directly related (via a one-to-one mandatory relationship) to the patient data entity 308 to convey that the OCR engine of the insurance verification system “outputs” the patient data recognized in and read from the image of the patient's insurance card. The image entity 304, in this example, may be related (via a one-to-one optional relationship) to the patient data entity 304 to convey that the image of the patient's insurance card “contains” the patient data recognized in and read from that insurance card and then output by the OCR engine of the insurance verification system. The patient entity 306, in this example, is directly related (via a one-to-one mandatory relationship) to the patient data entity 308 (e.g., using the patient's SSN as the primary key in the patient entity and as the foreign key in the patient data entity). The patient entity 306, in this example, also is directly related (via a one-to-one mandatory relationship) to the validation status entity 314 (e.g., using the unique identifier of the patient as the primary key in the patient entity and the foreign key in the validation status entity). The payor entity 310, in this example, is directly related (via a one-to-one mandatory relationship) to the payor data entity 312 (e.g., using the unique identifier of the payor as the primary key in the payor entity and the foreign key in the payor data entity). The patient entity 306, in this example, also is directly related (via a one-to-many relationship) to the payor data entity 312 (e.g., using the unique identifier of the patient (e.g., SSN) as the primary key in the patient entity and the foreign key in the payor data entity). The patient-payor data relationship thus conveys that a patient can be “enrolled in” one or more insurance plans, and the payor-payor data relationship conveys that a payor (e.g., insurance company) “enrolls” a patient in one of those insurance plans. Indirect relationships between the various entities shown in FIG. 3 will be apparent upon review of the various direct relationships described above.

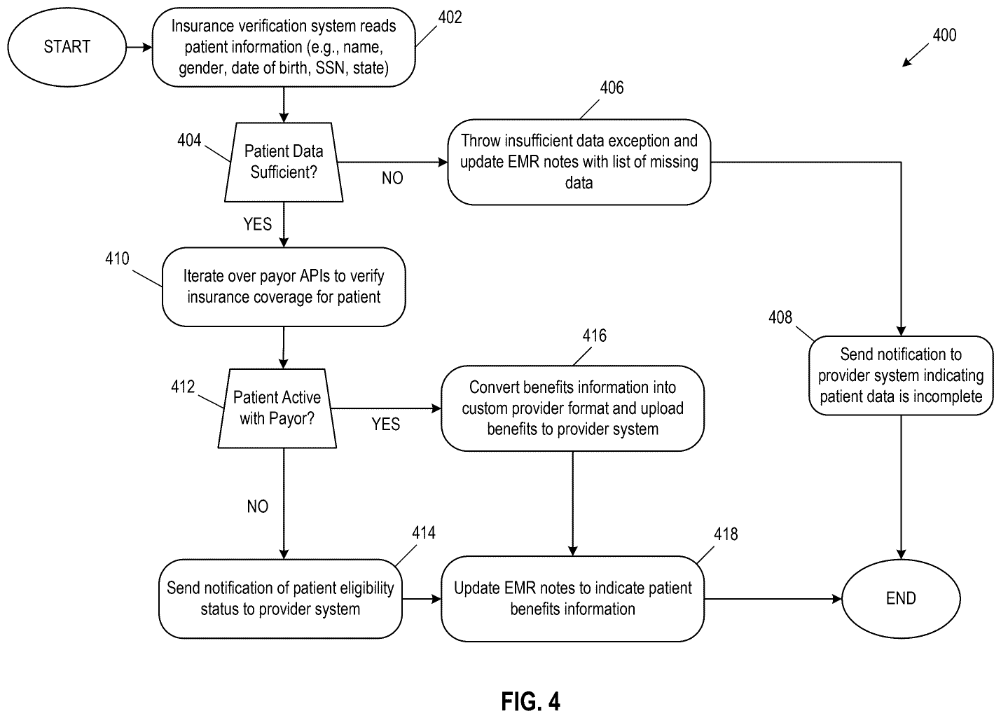

In FIG. 4, a flowchart 400 of example method steps related to verifying insurance coverage according to various aspects described herein is shown. The example method steps shown in FIG. 4 provide a relatively higher level overview of aspects related to insurance verification as described herein.

The insurance verification process may begin by an insurance verification system receiving patient information (step 402) as described herein. For example, as described herein, the insurance verification system may query an EHR/EMR system for some or all of the patient information, read some or all of the patient information from an image of the patient's insurance card, and/or receive some or all of the patient information from a provider system. The patient information may include, for example and as described herein, the patient's name, gender, date of birth, SSN, and state of residence.

The insurance verification system then evaluates the received patient data to determine if it is sufficient for insurance verification (step 404). If not (step 404: NO), the insurance verification system may throw an exception (step 406) (e.g., an insufficient data exception) and update the patient's EHR/EMR records (e.g., the notes section of such records) to indicate what patient data is missing and is otherwise needed to perform insurance verification. The insurance verification system may also send a notification to the provider system that requested verification of the patient's insurance to inform the provider that the patient data is incomplete and that insurance verification cannot be performed unless and until sufficient patient data is provided (step 408).

If, however, the received patient data is sufficient (step 404: YES), then the insurance verification system iterates over the library of payor APIs (step 410), as described herein, to determine whether any payor currently provides insurance coverage for the patient (step 412). If the insurance verification system determines that the patient is not active with any payor queried during the iterative search (step 412: NO), then the insurance verification system sends a notification to the provider system indicating that the patient's insurance coverage could not be verified (step 414).

If, however, the insurance verification system determines that the patient is active with a payor (step 412: YES), then the insurance verification system sends a notification to the provider system indicating that the patient's insurance coverage was successfully verified. The insurance verification system also may convert the patient's insurance information and any benefits information into a standard format or custom format (e.g., unique to the provider) and provide (e.g., upload) the insurance and benefits information to the provider system as described herein (step 416).

The insurance verification system also may update the patient's EHR/EMR records to note the determination regarding the patient's insurance coverage and benefits (step 418). The insurance verification system thus advantageously provides a technically grounded solution for efficiently verifying insurance coverage for patients thus minimizing potential delays in providing patients medical services.

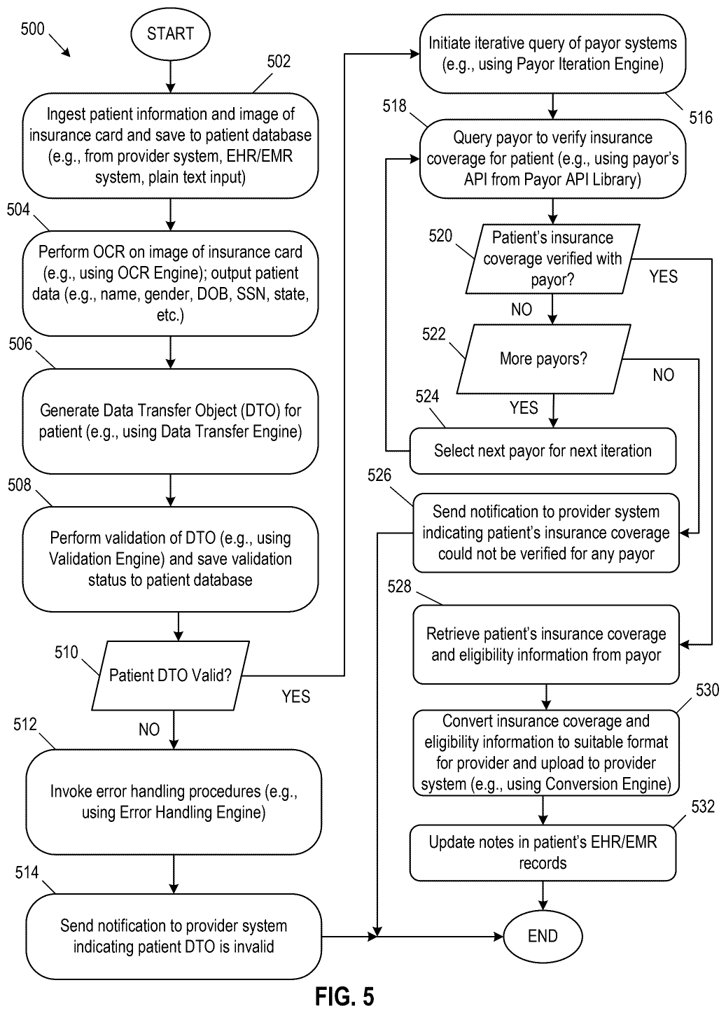

In FIG. 5, a flowchart 500 of example method steps also related to verifying insurance coverage according to various aspects described herein is shown. The example method steps shown in FIG. 5 provide a relatively more detailed view of aspects related to insurance verification as described herein.

Similar to the overview of the insurance verification process provided above with reference to FIG. 4, the insurance verification process begins with an insurance verification system ingesting patient information and an image of the patient's insurance card (step 502), which may be saved to a patient database as described herein. Some or all of the patient data may be ingested from a provider system, an EHR/EMR system, and/or via plain text entry. The ingestion may occur based on (e.g., in response to) the insurance verification system receiving a request to verify a patient's insurance from a provider system. The request may include some or all of the patient data and the insurance card image, the request may be sent via a client installed at the provider system and in signal communication with the insurance verification system. In that sense, the client may be considered to be a part of (e.g., a component of) the insurance verification system even though it resides at the provider system and is located remotely from other components of the insurance verification system that handle the validation and verification functions described herein.

The insurance verification system then performs OCR on the image of the patient's insurance card (step 504) as described herein. This OCR procedure may recognize the patient information on the insurance card depicted in the image and output the recognized patient information (e.g., name, gender, date of birth, SSN, state of residence, etc.). The recognized patient data read out from the image of the patient's insurance card is saved to the patient database as described herein.

The insurance verification system may then generate a DTO for the patient using the stored patient data (step 506) as described herein. The insurance verification system then validates the DTO generated for the patient and saves the validation status to the patient database (step 508) as also described herein. If the insurance verification system determines the DTO is not valid (step 510: NO) (e.g., is missing patient information needed for insurance verification), then the insurance verification system may invoke error handling procedures (step 512) as described herein. For example, the error handling procedures may include the insurance verification system sending a notification to the provider system that the patient DTO is invalid (step 514).

If, however, the insurance verification system determines that the patient DTO is valid (step 510: YES), then the insurance verification system may initiate an iterative query of the payor systems for any known payors (step 516) as described herein. For example, the insurance verification system may select a payor to query, obtain the appropriate API information for the selected payor from the payor API library, and query the payor using the payor's API to verify the patient's insurance coverage and eligibility information (step 518) as described herein. During the iterative search of the known payors, the insurance verification system attempts to verify the patient's insurance coverage and eligibility information with the currently selected payor (step 520). If the insurance verification system cannot verify the patient's insurance coverage information with the currently selected payor (step 520: NO), and if there are any remaining payors to query (step 522: YES), then the insurance verification system may select the next payor for the next iteration (step 524) and repeat the steps of obtaining the appropriate API information for the next selected payor and using it to verify the patient's insurance coverage and eligibility information with that next payor. If the insurance verification system cannot verify the patient's insurance coverage with any of the known payors (step 520: NO), then the insurance verification system may send a notification to the provider system indicating that the patient's insurance coverage could not be verified for any known payor (step 526). If, however, the insurance verification system successfully identifies a payor that verifies the patient's insurance coverage (step 520: YES), then the insurance verification system may retrieve the patient's insurance coverage and eligibility information from the payor (step 528), convert the insurance coverage and eligibility information to a suitable format for the requesting provider and send (e.g., upload) the converted and formatted insurance coverage and eligibility information to the provider system (step 530). The insurance verification information also may update the notes in the patient's EHR/EMR records to indicate the results of the insurance verification (step 532).

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

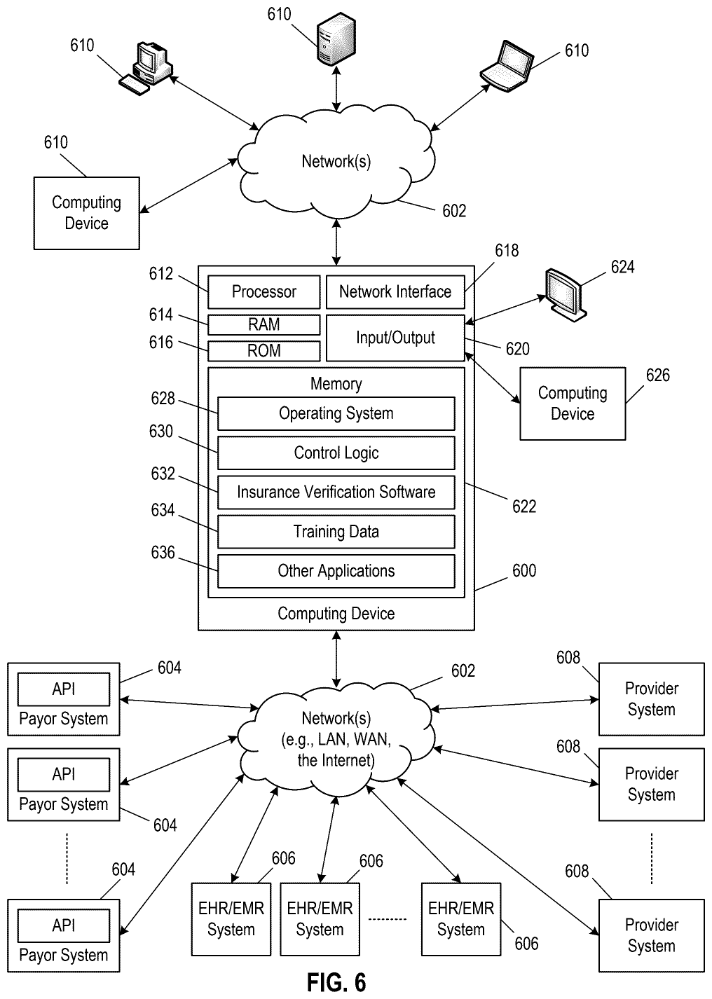

In FIG. 6, an example of a computing device 600 that may be used in implementing one or more aspects described herein is shown. For example, a computing device 600 may, in some examples, implement one or more aspects of the disclosure by reading and/or executing instructions and performing one or more actions based on the instructions. The computing device 600 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The computing device 600 may, in some examples, operate in a standalone environment. In other examples, the computing device 600 may operate in a networked environment. As seen in FIG. 6, various nodes may be interconnected via a network 602, such as the Internet. The nodes may include, for example, one or more payor systems 604, one or more EHR/EMR systems 606, one or more provider systems 608, and/or other types of computing devices 610. Other networks may additionally or alternatively be used, including private intranets, corporate networks, LANs, wireless networks, personal networks (PAN), etc. The network 602 shown in FIG. 6 is for illustration purposes and may be replaced with fewer or additional computer networks. A LAN may have one or more of any known LAN topology and may use one or more of a variety of different protocols, such as Ethernet. The nodes (e.g., systems, devices) shown in FIG. 6 and other devices (not shown) may be connected to one or more of the networks via twisted pair wires, coaxial cable, fiber optics, radio waves or other communication media.

As seen in FIG. 6, the computing device 600 may include a processor 612, RAM 614, ROM 616, network interface 618, input/output interfaces 620 (e.g., keyboard, mouse, display, printer, etc.), and memory 622. The processor 612 may include one or more computer processing units (CPUs), graphical processing units (GPUs), and/or other processing units such as a processor adapted to perform computations associated with verifying insurance coverage using an iterative methodology and/or forms of machine learning. The I/O 620 may include a variety of interface units and drives for reading, writing, displaying, and/or printing data or files. The I/O may be coupled with a display 624 and/or with another computing device 626. The memory may store software for configuring computing device into a special purpose computing device in order to perform one or more of the various functions discussed herein. The memory may store operating system software 628 for controlling overall operation of the computing device, control logic 630 for instructing computing device to perform aspects discussed herein, insurance verification software 632 configured to perform any of the processes and/or methods described above, training data 634 that is usable to train any or all of the machine-learning models discussed above, and other applications 636. The control logic 63—may be incorporated in and may be a part of the insurance verification software 632. In other examples, the computing device 600 may include two or more of any and/or all of these components (e.g., two or more processors 612, two or more memories 622, etc.) and/or other components and/or subsystems not illustrated here.

The other devices and/or systems shown in FIG. 6 may have similar or different architecture as described with respect to the computing device. Those of skill in the art will appreciate that the functionality of the computing device (or other computing devices) as described herein may be spread across multiple data processing devices, for example, to distribute processing load across multiple computers, to segregate transactions based on expected parallel processing efficiencies, geographic location, user access level, quality of service (QOS), to use cloud-based computing services, etc. For example, multiple computing devices may operate in concert to provide parallel computing features in support of the operation of the control logic 630, insurance verification software 632, and/or the other applications 636.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer readable medium such as a hard disk, optical disk, removable storage media, solid state memory, RAM, etc. The functionality of the program modules may be combined or distributed as desired in various embodiments. The functionality also may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although the subject matter has been described in language specific to structural features and/or methodological acts, it is to be understood that the subject matter defined in any statement of example embodiments is not necessarily limited to the specific features or acts described above. Furthermore, the operations described herein may be conditional. For example, various operations may be performed if certain criteria are met. If the one or more criteria are met, various examples may be used. It may be possible to implement any portion of the examples described herein in any order and based on any condition.

While aspects of the present disclosure have been described in terms of preferred examples, and it will be understood that the disclosure is not limited thereto since modifications may be made to those skilled in the art, particularly in light of the foregoing teachings. For example, although various examples are described herein, features and/or steps of those examples may be combined, divided, omitted, rearranged, revised, and/or augmented in any desired manner. Various alterations, modifications, and improvements will be appreciated by those skilled in the art and are intended to be part of this description, even if not expressly stated herein, and are intended to be within the spirit and scope of the disclosures herein. The disclosures herein, therefore, are by way of example only, and are not limiting.

What is claimed is:

1. A computing system for iteratively querying a plurality of payor computing systems to verify payment coverage for a recipient of service of a service provider, the computing system comprising:
one or more processors;
a database storing a plurality of Application Programming Interface (API) specifications, wherein each API specification defines an API exposed by a respective one of the payor computing systems; and
memory storing instructions that, when executed by the one or more processors, configure the computing system to:
receive, from a service provider system of the service provider, a request to verify payment coverage for the recipient of the service;
iterate over the plurality of API specifications to verify payment coverage for the recipient at least by, at each iteration:
retrieving, from the database, an API specification for a payor computing system of the plurality of payor computing systems;
constructing a verification request based on the retrieved API specification;
establishing an electronic connection, via one or more computing networks, with the payor computing system based on the retrieved API specification;
submitting, via the electronic connection, the verification request to the payor computing system based on the retrieved API specification; and
receiving, via the electronic connection and in response to the submitted verification request, a verification response from the payor computing system indicating whether a payor associated with the payor computing system provides payment coverage for the recipient;
based on at least one verification response indicating a payor that provides payment coverage for the recipient, sending to the service provider system an indication of an identity of the payor that provides payment coverage for the recipient; and
based on no verification response indicating a payor that provides payment coverage for the recipient, sending to the service provider system an indication that payment coverage for the recipient could not be verified.

2. The computing system of claim 1, further comprising:
an image classification model trained to indicate an identity of a payor, of a plurality of payors, associated with an insurance card image input into the image classification model;
a plurality of image segmentation models, wherein each image segmentation model is trained to segment an insurance card image for a respective one of the plurality of payors into a plurality of segments that each respectively indicate information used to verify payment coverage;
wherein the instructions, when executed by the one or more processors, further configure the computing system to:
receive, from a service provider system of the service provider, an insurance card image associated with the recipient;
identify, by providing the received insurance card image to the image classification model, a payor indicated by the received insurance card image;
segment, by providing the received insurance card image to an image segmentation model associated with the identified payor, the received insurance card image into a plurality of segments; and
obtain, from one or more segments of the plurality of segments using optical character recognition, information used to verify payment coverage for the recipient; and
wherein the instructions, when executed by the one or more processors, configure the computing system to construct the verification request further based on the information obtained from the one or more segments.

3. The computing system of claim 1, wherein the instructions, when executed by the one or more processors, configure the computing system to iterate over the plurality of API specifications at least by iterating over the plurality of API specifications based on insured population size, wherein the computing system is configured to perform a first iteration for a first payor determined to have a first insured population size before a second iteration for a second payor determined to have a second insured population size that is smaller than the first insured population size.

4. The computing system of claim 1, wherein the instructions, when executed by the one or more processors, configure the computing system to iterate over the plurality of API specifications at least by iterating over the plurality of API specifications based on a geographic location of the recipient, wherein the computing system is configured to perform a first iteration for a first payor that is located in the same geographic location as the recipient before a second iteration for a second payor that is not located in the same geographic location as the recipient.

5. The computing system of claim 1, wherein:
the plurality of APIs comprises a first API designated as a default API for a payor and a second API designated as a backup API for the payor; and
the instructions, when executed by the one or more processors, configure the computing system to, based on determining that the default API is not available to verify payment coverage by the payor for the recipient, attempt to verify payment coverage by the payor for the recipient using the backup API.

6. The computing system of claim 1, wherein the instructions, when executed by the one or more processors, further configure the computing system to:
convert a format of information included in the received verification request into a standardized format using one or more data model standards;
convert, for a first iteration, information used to verify payment coverage from the standardized format to a first format based on a first API for a first payor; and
convert, for a second iteration, information used to verify payment coverage from the standardized format to a second format based on a second API for a second payor.

7. The computing system of claim 1, wherein:
the request to verify the payment coverage for the recipient is a batch request to verify payment coverage for a plurality of recipients; and
the instructions, when executed by the one or more processors, further configure the computing system to iterate over the plurality of recipients indicated in the batch request to respectively verify payment coverage for the plurality of recipients.

8. The computing system of claim 1, wherein the instructions, when executed by the one or more processors, further configure the computing system to convert a format of information included in the received verification response into a standardized format using a standardized response data model.

9. A computer-implemented method for iteratively querying a plurality of payor computing systems to verify payment coverage for a recipient of service of a service provider, the computer-implemented method comprising;
storing, in a database, a plurality of Application Programming Interface (API) specifications, wherein each API specification defines an API exposed by a respective one of the payor computing systems;
receiving, from a service provider system of the service provider, a request to verify payment coverage for the recipient of the service;
iterating over the plurality of API specifications to verify payment coverage for the recipient, wherein each iteration comprises:
retrieving, from the database, an API specification for a payor computing system of the plurality of payor computing systems;
constructing a verification request based on the retrieved API specification;
establishing an electronic connection, via one or more computing networks, with the payor computing system based on the retrieved API specification;
submitting, via the electronic connection, the verification request to the payor computing system based on the retrieved API specification; and
receiving, via the electronic connection and in response to the submitted verification request, a verification response from the payor computing system indicating whether a payor associated with the payor computing system provides payment coverage for the recipient; and
sending, to the service provider system and based on at least one received verification response, either an indication of an identity of the payor that provides payment coverage for the recipient or an indication that payment coverage for the recipient could not be verified.

10. The computer-implemented method of claim 9, further comprising:
training an image classification model to indicate an identity of a payor, of a plurality of payors, associated with an insurance card image input into the image classification model at least by providing, to the image classification model, a plurality of first insurance card images, wherein each first insurance card image is labeled with an indication of an identity of a payor of the plurality of payors;
training a plurality of image segmentation models to segment an insurance card image into a plurality of segments that each indicate respective information used to verify payment coverage at least by providing, to each image segmentation model, a plurality of second insurance card images, wherein each second insurance card image is labeled with at least one indication of a type of information used to verify payment insurance coverage depicted in a segment of the second insurance card image;
receiving, from the service provider system of the service provider, an insurance card image associated with the recipient;
identifying, by providing the received insurance card image to the trained image classification model, a payor indicated by the received insurance card image;
segmenting, by providing the received insurance card image to an image segmentation model associated with the identified payor, the received insurance card image into a plurality of segments;
obtaining, from one or more segments of the plurality of segments using optical character recognition, information used to verify payment coverage for the recipient; and
constructing the verification request further based on the information obtained from the one or more segments.

11. The computer-implemented method of claim 9, wherein the iterating over the plurality of API specifications is based on insured population size and the iterating comprises performing a first iteration for a first payor determined to have a first insured population size before performing a second iteration for a second payor determined to have a second insured population size that is smaller than the first insured population size.

12. The computer-implemented method of claim 9, wherein the iterating over the plurality of API specifications is based on a geographic location of the recipient and the iterating comprises performing a first iteration for a first payor that is located in the same geographic location as the recipient before performing a second iteration for a second payor that is not located in the same geographic location as the recipient.

13. The computer implemented method of claim 9, wherein:
the plurality of APIs comprises a first API designated as a default API for a payor and a second API designated as a backup API for the payor; and
the method further comprises, based on determining that the default API is not available to verify payment coverage by the payor for the recipient, attempting to verify payment coverage by the payor for the recipient using the backup API.

14. The computer-implemented method of claim 9, further comprising:
converting a format of information included in the received verification request into a standardized format using one or more data model standards;
converting, for a first iteration, information used to verify payment coverage from the standardized format to a first format based on a first API for a first payor; and
converting, for a second iteration, information used to verify payment coverage from the standardized format to a second format based on a second API for a second payor.

15. A non-transitory computer-readable medium storing instructions for iteratively querying a plurality of payor computing systems to verify payment coverage for a recipient of a service of a service provider, wherein the instructions, when executed by one or more processors of a computing system, cause the computing system to:
store, in a database, a plurality of Application Programming Interface (API) specifications, wherein each API specification defines an API exposed by a respective one of the payor computing systems;
receive, from a service provider system of the service provider, a request to verify payment coverage for the recipient of the service;
iterate over the plurality of API specifications to verify payment coverage for the recipient, wherein each iteration comprises:
retrieving, from the database, an API specification for a payor computing system of the plurality of payor computing systems;
constructing a verification request based on the retrieved API specification;
establishing an electronic connection, via one or more computing networks, with the payor computing system based on the retrieved API specification;
submitting, via the electronic connection, the verification request to the payor computing system based on the retrieved API specification; and
receiving, via the electronic connection and in response to the submitted verification request, a verification response from the payor computing system indicating whether a payor associated with the payor computing system provides payment coverage for the recipient; and
send, to the service provider system and based on at least one received verification response, either an indication of an identity of the payor that provides payment coverage for the recipient or an indication that payment coverage for the recipient could not be verified.

16. The non-transitory computer-readable medium of claim 15, wherein the instructions, when executed by the one or more processor, further cause the computing system to:
train an image classification model to indicate an identity of a payor, of a plurality of payors, associated with an insurance card image input into the image classification model at least by providing, to the image classification model, a plurality of first insurance card images, wherein each first insurance card image is labeled with an indication of an identity of a payor of the plurality of payors;
train a plurality of image segmentation models to segment an insurance card image into a plurality of segments that each indicate respective information used to verify payment coverage at least by providing, to each image segmentation model, a plurality of second insurance card images, wherein each second insurance card image is labeled with at least one indication of a type of information used to verify payment insurance coverage depicted in a segment of the second insurance card image;
receive, from the service provider system of the service provider, an insurance card image associated with the recipient;
identify, by providing the received insurance card image to the trained image classification model, a payor indicated by the received insurance card image;
segment, by providing the received insurance card image to an image segmentation model associated with the identified payor, the received insurance card image into a plurality of segments;
obtain, from one or more segments of the plurality of segments using optical character recognition, information used to verify payment coverage for the recipient; and
construct the verification request further based on the information obtained from the one or more segments.

17. The non-transitory computer-readable medium of claim 15, wherein the instructions, when executed by the one or processors, further cause the computing system to iterate over the plurality of API specifications is based on one of:
insured population size wherein a first iteration for a first payor determined to have a first insured population size is performed before a second iteration for a second payor determined to have a second insured population size that is smaller than the first insured population size; or
a geographic location of the recipient wherein a first iteration for a first payor that is located in the same geographic location as the recipient is performed before a second iteration for a second payor that is not located in the same geographic location as the recipient.

18. The non-transitory computer-readable medium of claim 15, wherein:
the plurality of APIs comprises a first API designated as a default API for a payor and a second API designated as a backup API for the payor; and
the instructions, when executed by the one or more processors, further cause the computing system to, based on determining that the default API is not available to verify payment coverage by the payor for the recipient, attempt to verify payment coverage by the payor for the recipient using the backup API.

19. The non-transitory computer-readable medium of claim 15, wherein the instructions, when executed by the one or processors, further cause the computing system to:
convert a format of information included in the received verification request into a standardized format using one or more data model standards;
convert, for a first iteration, information used to verify payment coverage from the standardized format to a first format based on a first API for a first payor; and
convert, for a second iteration, information used to verify payment coverage from the standardized format to a second format based on a second API for a second payor.

20. The non-transitory computer-readable medium of claim 15, wherein:
the request to verify payment coverage is a request to verify insurance coverage by an insurance provider; and
the insurance provider is one of a medical insurance provider, an automobile insurance provider, or a home insurance provider.
